(19) United States
(12) Patent Application Publication
(10) Pub. No.: US 2017/0142329 A1
(43) Pub. Date: May 18, 2017

(54) Golfer's Eye View

(71) Applicant: David T Pelz, Dripping Springs, TX (US)

(72) Inventor: David T Pelz, Dripping Springs, TX (US)

(21) Appl. No.: 15/350,034

(22) Filed: Nov. 12, 2016

Related U.S. Application Data
(60) Provisional application No. 62/254,413, filed on Nov. 12, 2015.

(51) Int. Cl. H04N 5/232; H04N 5/247; G09B 5/02; A63B 71/06; A63B 69/00; A63B 69/38; A63B 69/36; H04N 7/18; G09B 19/00

(52) U.S. Cl. CPC H04N 5/23219; H04N 5/23216; H04N 7/181; H04N 5/247; G09B 5/02; G09B 19/0038; A63B 69/0002; A63B 69/0071; A63B 69/385; A63B 69/36; A63B 71/0622; G06F 3/04842

(57) ABSTRACT

In some embodiments, a system may include a wearable device having at least one optical sensor configured to capture optical data corresponding to a view area and one or more eye tracking sensors configured to detect eye movement. The wearable device may further include a processor configured to determine a portion of the optical data based on the detected eye movement.

### CROSS-REFERENCE TO RELATED APPLICATION(S)

The present disclosure is a non-provisional of and claims priority to U.S. Provisional Application No. 62/254,413 filed on Nov. 12, 2015 and entitled “Golfer's Eye View”, which is incorporated herein by reference in its entirety.

### FIELD

The present disclosure is generally related to capturing the view or perspective of an athlete, such as a golfer as he or she performs an activity.

### BACKGROUND

Video cameras typically capture one or more views of an athlete, but the cameras do not capture the images from the view point of what the athlete's eyes actually do or should see. More particularly, it can be very difficult to replicate what the athlete sees. In particular, head-mounted cameras are typically directed in a forward direction; however, while such cameras may capture a forward view area corresponding to a direction that the wearer's head is turned, the camera captures a wide view area that does not discriminate between all of the visible objects within the view area and the particular portion of the view area of interested to the wearer.

### SUMMARY

Embodiments of systems and methods may include a wearable device configured to capture optical data associated with a view area. The wearable device may further include eye tracking sensors configured to track the user's eye movements and focus as he or she looks at the relevant (for instructional purposes) viewing area. In certain embodiments, the wearable device may include a processor configured to provide a portion of the optical data to a display device or to an external computing device based on the tracked eye data.

In some embodiments, a system may include a wearable device having at least one optical sensor configured to capture optical data corresponding to a view area and one or more eye tracking sensors configured to detect eye movement. The wearable device may also include a processor configured to determine a portion of the optical data based on the detected eye movement. In some aspects, the system may also include a computing device configured to communicate with the wearable device.

In other embodiments, a system may include a wearable device. The wearable device may include a transceiver, at least one optical sensor configured to capture optical data corresponding to a view area, and one or more eye tracking sensors configured to detect eye movement. The wearable device may further include a processor coupled to the at least one optical sensor, the eye tracking sensors, and the transceiver. The processor may be configured to determine focal data correlating the eye movement relative to the optical data and communicate the optical data and the focal data to a computing device via the transceiver.

In still other embodiments, a method may include capturing optical data corresponding to a forward view using at least one optical sensor of a wearable device and determining, using eye tracking sensors of the wearable device, focal data corresponding to eye movements of a user. The method may also include transmitting, using a transceiver of the wearable device, at least one of a portion of the optical data and the focal data to a computing device.

### BRIEF DESCRIPTION OF THE DRAWINGS

FIG. 1A depicts a perspective view of a wearable element configured to provide a view point of a user, in accordance with certain embodiments of the present disclosure.

FIG. 1B depicts a block diagram of the wearable element of FIG. 1A, in accordance with certain embodiments of the present disclosure.

FIG. 2 depicts a diagram of a range of optical data and portions corresponding to two focus areas of the user, in accordance with certain embodiments of the present disclosure.

FIG. 3 depicts a system including a wearable element and a computing device, in accordance with certain embodiments of the present disclosure.

FIG. 4 depicts an interface including optical data including a first portion corresponding to a first focus area of the user and a second portion corresponding to a second focus area of the user, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Embodiments of a wearable device or element are described below that may include a first camera configured to capture a first view, a second camera configured to capture a second view and a processor coupled to the first camera and the second camera. The processor may further be coupled to one or more eye tracking sensors configured to monitor eye movements and focus of eyes of a user to determine a portion of at least one of the first view and the second view corresponding to a focus of the user. In some examples, the wearable device or element may be configured to communicate data including video of the first view, video of the second view, and data related to the determined eye movements and focus to another device. In some embodiments, the processor may modify one of the first view and the second view based on signals from the eye tracking sensors before communicating the data.

In some examples, the device may be worn by an athlete, while he or she performs an activity, such as shooting a jump shot, hitting a baseball, hitting a golf ball, serving a tennis ball, The first camera may capture a view corresponding to the eye movements and focus of the user's eyes. The second camera may capture a view corresponding to the area toward which the user is striking the ball, such as the tennis court, a baseball field, a golf course, and so on. Thus, the captured videos from the first view and the second view may provide video corresponding to what an athlete sees when he or she is performing an action, which video may be used for training purposes.

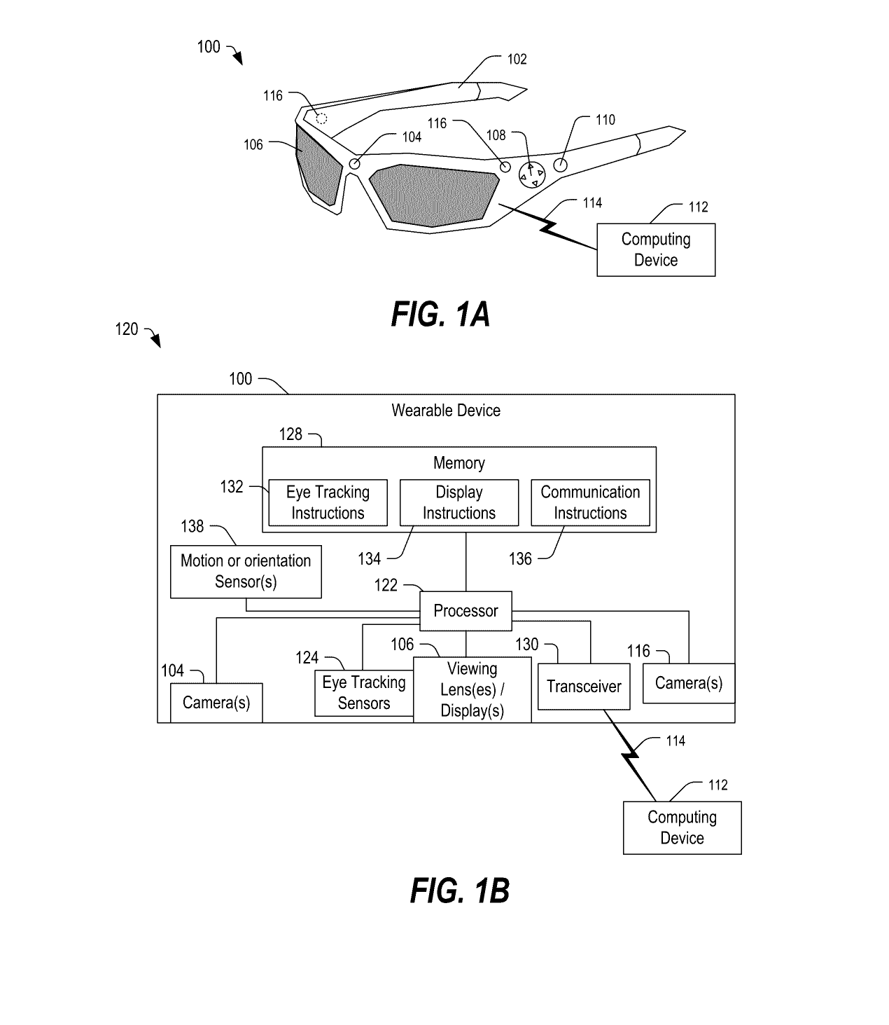

Embodiments of a wearable device may include eyeglasses, goggles, a visor or hat, a headband, other headwear, or any combination thereof. In some embodiments, the wearable device may be positioned to allow one or more eye-tracking sensors to monitor eye movements and eye focus of the wearer while video frames are being captured. One possible example of an embodiment of a wearable device is described below with respect to FIG. 1A.

FIG. 1A depicts a perspective view of a wearable device 100 configured to provide a view point of a user, in accordance with certain embodiments of the present disclosure. The wearable device 100 includes an eyeglass frame 102, including at least one camera 104 embedded in the frame and including view lenses/displays 106 through which a user may view optical data corresponding to a view area. In an example, the at least camera 104 may capture optical data in a “forward” direction corresponding to an orientation of the user's head. In some embodiments, the wearable device 100 may include additional cameras 116 on either side to provide a range of view that extends to the sides of the wearable device 100. The additional cameras 116 may capture image data corresponding to views having an orientation that is approximately orthogonal to or perpendicular to the forward direction, thereby providing optical data corresponding to approximately 270 degrees including the forward and peripheral views of the user. Further, the wearable device 100 may include a battery to supply power to the various components.

The wearable device 100 may include user selectable elements, such as a rocker switch 108 and a button 110 to interact with menu items provided to the lenses/displays 106 or to control operation of the wearable device 100. In an example, the user may interact with at least one of the rocker switch 108 and the button 110 to specify right-handed or left-handed activities, which may cause a processor of the wearable device 100 to activate one of the cameras 116 and to deactivate the others, thereby conserving power and extending the life of the battery. In certain embodiments, the wearable device 100 may include a transceiver configured to communicate optical data, eye tracking data, timing data, and other data to a computing device 112 through a communications link 114, which may be wired or wireless.

In an example, the wearable device 100 may be worn by an athlete while he or she is performing a particular activity, such as setting up for a shot. The wearable device 100 may monitor the user's eye movements and focus and may captured video corresponding to the user's focus. The captured video may be used to assist in training other, less-experienced athletes, for example, to adopt an approach consistent with that of a more experienced athlete.

Similarly, in other fields of endeavor, the captured video may be used to facilitate training to assist the user in viewing what a more experienced user would view, thereby assisting the user in adjusting his or her behavior to model the more experienced user (shortening the training time). In some embodiments, the wearable device 100 may communicate a portion of the captured video that corresponds to the user's focus to a computing device, such a laptop, a tablet, a smart phone, or another computing device, which may further process the video into a suitable graphical display. In some examples, a trainer may review the video with a trainee to describe and explain various elements within the video.

FIG. 1B depicts a block diagram 120 of the wearable device 100 of FIG. 1A, in accordance with certain embodiments of the present disclosure. The wearable device 100 may include all of the elements of FIG. 1A. Further, the wearable device 100 may include a processor 122 coupled to the cameras 104 and to the viewing lenses/displays 106. In a particular embodiment, the viewing lenses/displays 106 may be transparent to allow a wearer to see his or her environment. In some instances, the viewing lenses/displays 106 may also be configured to project or display a digital overlay or heads up display on at least a portion of the lenses/displays 106. The digital overlay can include data, such as range information, score information, or other information, which may be determined from the optical data or from other sensors.

The processor 122 may also be coupled to eye tracking sensors 124 configured to track eye movement and focus and to communicate eye tracking data to the processor 122. The eye tracking sensors 124 may be configured to measure the point of gaze of the user or the motion of the user's eye relative to the head. In some embodiments, the eye tracking sensors 124 may be configured to optically monitor eye motion. In a particular example, the eye tracking sensors 124 can receive light reflected from the user's eye and can extract eye movement and focus variations from the reflected light. In some examples, the eye tracking sensors 124 can use corneal reflection and the center of the pupil as features to track and may a focal vector from such information, which focal vector may be used to determine portions of the video data that correspond to the user's focus. Further, the wearable device 100 can include one or more motion or orientation sensors 138 that may provide signals to the processor 122 that may be proportional to the orientation of the wearable device 100. In some embodiments, the processor 122 may utilize signals from the eye tracking sensors 124 and from the motion or orientation sensors 138 to determine an orientation of the user's head while also tracking the user's eye movements in order to discern the focus of the user (i.e., focal data corresponding to the focus of the user). The processor 122 may also be coupled to additional cameras 116, to a memory device 128, and to a transceiver 130, which may communicate image data, eye tracking data, and other data to the computing device 112 through the communications link 114.

In some embodiments, the memory 128 may store eye tracking instructions 132 that, when executed, may cause the processor 122 to process the signals from the eye tracking sensors 124 to determine eye movements and the portions of the viewing area on which the user is focusing his attention. The memory 128 may further include display instructions that, when executed, may cause the processor 122 to identify the portions of the optical data captured by cameras 104 and 116 that correspond to the portions of the viewing area. The memory 128 may also include communication instructions that, when executed, may cause the processor 122 to send the data to the computing device 112.

In some embodiments, the data may include the entirety of the image data captured by the cameras 104 and 116, eye tracking data from the eye tracking sensors 124, identified portions of the optical data determined by the processor 122, timing data, other data, or any combination thereof. Other embodiments are also possible.

In certain embodiments, such as when a golfer is setting up to hit a golf shot, such as a drive, a chip, or a putt, the golfer may look down at the ball and at his/her feet and then may look toward the target area for the shot. In some instances, the golfer's head turns are less than a full ninety degrees, and the view encompasses at least some of the golfer's peripheral vision.

It should be appreciated that traditional techniques to attempt to replicate the user's view typically rely on the orientation of the user's head, but do not actually track the user's eye movements, which may not always be directed in a forward direction. Accordingly, such images simulate the user's view point but fail to provide an actual view corresponding to the user's optical focus.

In certain embodiments, the cameras 104 and 116 may cooperate to capture images of the view area that are much greater than the area being viewed by the golfer, and the eye tracking data may be used by the processor 122 to identify portions of the captured optical data that correspond to the viewing focus of the golfer. Those portions may be provided to the computing device 112. Other embodiments are also possible.

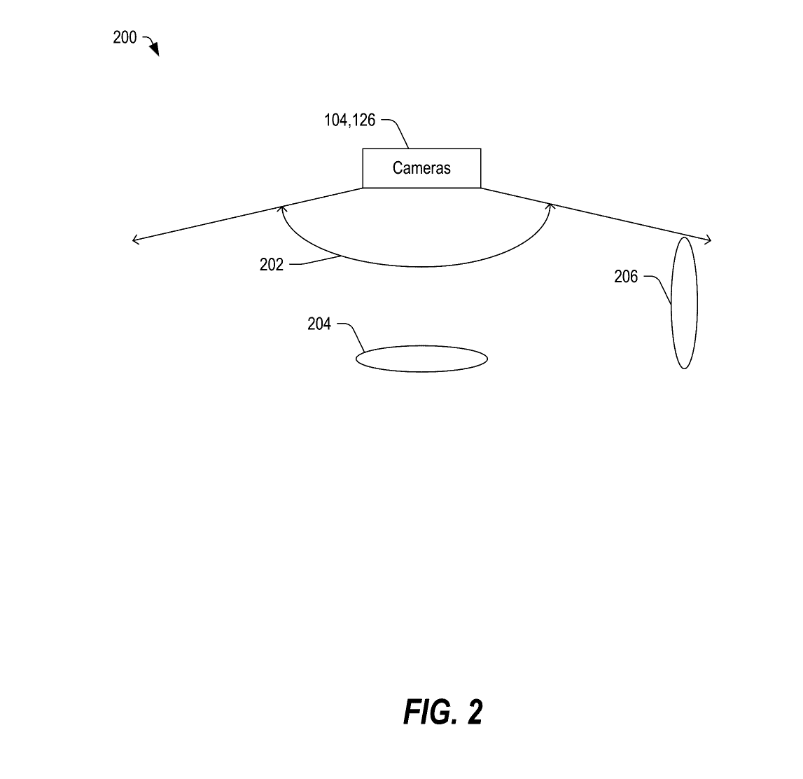

FIG. 2 depicts a diagram 200 of a range 202 of optical data and portions 204 and 206 corresponding to two focus areas of the user, in accordance with certain embodiments of the present disclosure. The cameras 104 and 116 may capture a wide range 202, and the user may focus on small portions of the image data, which small portions 204 and 206 may be determined from the eye tracking data.

In an embodiment involving a golfer, the golfer may look down at a first portion 204 of the visual data, and may look up at a second portion 206 of the visual data. Other portions may also receive attention and may be identified based on the eye tracking data. In this example, the golfer may look at the ball (first portion 204) and may look at the target (second portion 206).

In some embodiments, the cameras 104 and 116 may capture image data that includes the visual objects on which the user is focusing as well as image data corresponding to the surrounding area. The processor 122 may utilize the eye tracking data from the eye tracking sensors 124 to identify those portions of the image data that correspond to the user's focus. In some embodiments, the processor 122 may cause the transceiver 130 to communicate the image data from the cameras 104 and 116 as well as data related to those portions of the image data that correspond to the user's focus. In one example, the processor 122 may cause the transceiver 130 to communicate focus data that identifies a range of pixels or a portion of the image data that corresponds to the user's focus. In another example, the processor 122 may cause the transceiver 130 to communicate a portion of the image data corresponding to the user's focus. Other embodiments are also possible.

In a particular embodiment, the computing device 112 (in FIG. 1) may execute a software application that a graphical interface that includes a first portion configured to display the portion of the image data corresponding to the user's focus and that includes a second portion configured to display at least a second portion of the image data.

In a particular embodiment, the wearable device 100 may be used in conjunction with the computing device 112 to capture images that can selected to reflect a first view corresponding to the user's optical perspective and a second view corresponding to an area toward which the user's activities may be directed. In some instances, the two views may have significant overlap. In other instances, the wearable device 100 may capture image data corresponding to the user's focus in one direction (such as toward a golf ball on the ground or on a tee), and the wearable device 100 may also capture image data corresponding to the target area toward which the user's activities may be directed (such as a fairway, a green, or another area). In the context of tennis, the user may be focused on the ball, while the second direction corresponds to a target area on an opposing side of the net, and so on. Other examples are also possible.

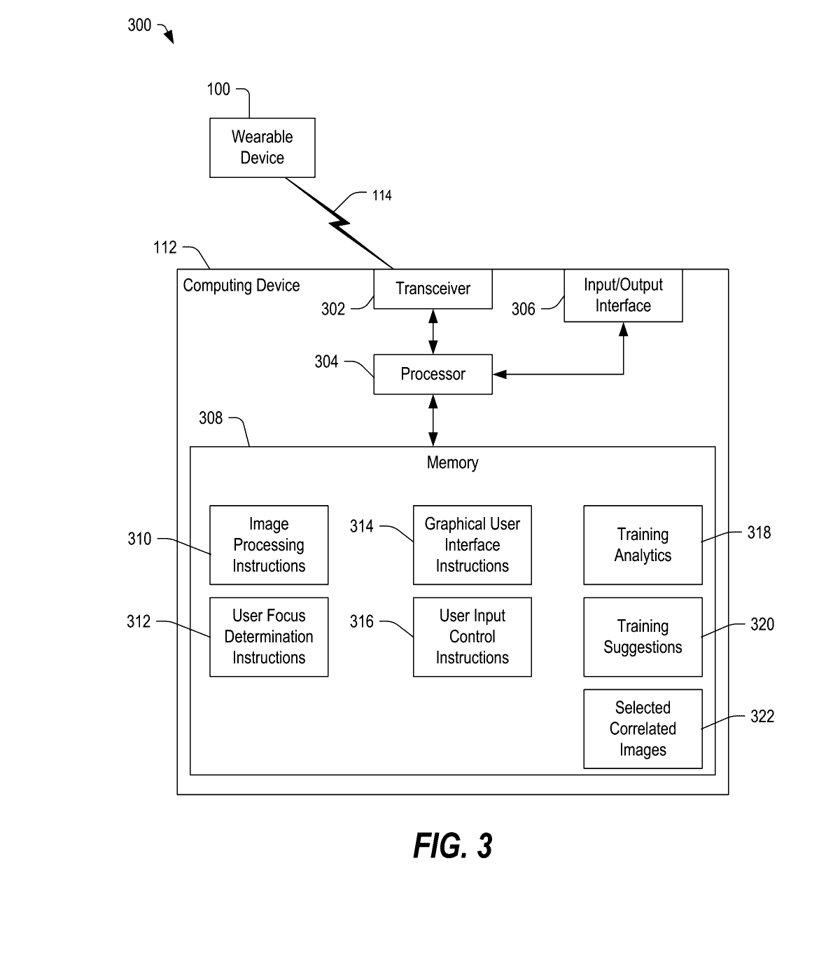

To produce training material from such user activity, it may be desirable to have an experienced user perform an activity while wearing the wearable device 100. The captured image data may be communicated to the computing device 112 through the communications link 114 together with the focal data. The computing device 112 may then present the various views and allow the user to scroll through the images to pick suitable images from both the user's perspective and the target area views for the training material. One possible example of a system configured to display portions of the image data is described below with respect to FIG. 3.

FIG. 3 depicts a system 300 including a wearable element 100 and a computing device 112, in accordance with certain embodiments of the present disclosure. The wearable element 100 may be configured to send image data and user focus data to the computing device 112 through a communications link, such as the wireless connection 114.

The computing device 112 may include a transceiver 302 configured to send data to and receive data from the wearable device 100. The computing device 112 may further include a processor 304 coupled to the transceiver 302, to an input/output interface 306, and to a memory 308. In some embodiments, the input/output interface 306 may include a display and a keyboard. In some embodiments, the input/output interface 306 may include a touchscreen.

The memory 308 may be configured to store data and to store instructions that, when executed, may cause the processor 304 to process video frames received from the wearable device 100 and to produce an interface (such as a graphical user interface) that can be provided to the input/output interface 306 for display to a user. The memory 308 may include image processing instructions 310 that, when executed, may cause the processor 304 to receive image data from the wearable device 100 and to process the image data to determine at least a portion of the image data for inclusion within a graphical interface. In some embodiments, the image processing instructions 310 may further cause the processor 304 to include text and other data as an overlay to the image data. For example, the processor 304 may include a distance to the pin for a golfer or may include other data.

The memory 308 may include user focus determination instructions 312 that, when executed, may cause the processor 304 to process the focus data received from the wearable device 100 that indicates a direction of focus of the user's eyes to determine at least a portion of the image data that corresponds to the user's focus. In some embodiments, the processor 304 may provide the portion of the image data corresponding to the user's focus for inclusion in the graphical interface.

The memory 308 may also include graphical user interface instructions 314 that, when executed, may cause the processor 304 to produce a graphical interface (such as a web browser window or an application window) including the image data and the portion corresponding to the user's focus. Further, in some embodiments, the graphical interface may further include user-selectable elements, such as links, buttons, tabs, or tools that can be selected to interact with the image data, the portion, or any combination thereof. In an example, a user may select a drawing tool to draw a line or another shape as an overlay to the image to demonstrate a particular aspect of what is shown and may subsequently select an erase tool to erase the line or shape or to erase a portion of the line or shape. Other tools are also possible.

The memory 308 can also include user input control instructions 316 that, when executed, may cause the processor 304 to adjust the image data within the graphical interface. Further, the user input control instructions 316 may cause the processor 304 to send one or more commands to the wearable element 100 to adjust its operation. In an example, the commands may include instructions that cause the wearable element 100 to send video data corresponding to a selected one of the cameras 104 and 116. Other embodiments are also possible.

In a particular embodiment, the memory 308 may include training analytics 318 that, when executed, may cause the processor 304 to process the portion corresponding to the user's focus and to selectively highlight elements within the portion that the user is focusing on. In an example, the processor 304 may perform boundary detection or blob detection on objects within the video frame and may apply adjust the contrast along the boundaries of a particular object. In an example involving golf, the processor 304 may execute the training analytics to identify an angle of the club face relative to the alignment of the golfer's feet, and may trace a line from the toe of one shoe to the toe of the other shoe to show the user's foot alignment and may trace a line along the club face and extending to intersect the line showing the foot alignment. In some examples, depending on the club selection (e.g., sand wedge, driver, etc.), the training analytics 318 may be configured to trace an ideal alignment line to provide visual instructions for improving the shot alignment. Further, the memory 308 may include training suggestions 320 that, when executed, may cause the processor 304 to provide tips and tricks for improving an identified element, which tips and tricks may be utilized by a user to improve his or her performance.

Further, the memory 308 can include selected correlated images 322, which may be images selected from the image portions corresponding to the eye tracking data and images selected from the target area views. The images may be correlated to provide the dual perspectives in conjunction with one another. Selected tips and tricks from the training suggestions 320 and other features may be added to the selected images to depict what the trainer is trying to explain. Other embodiments are also possible.

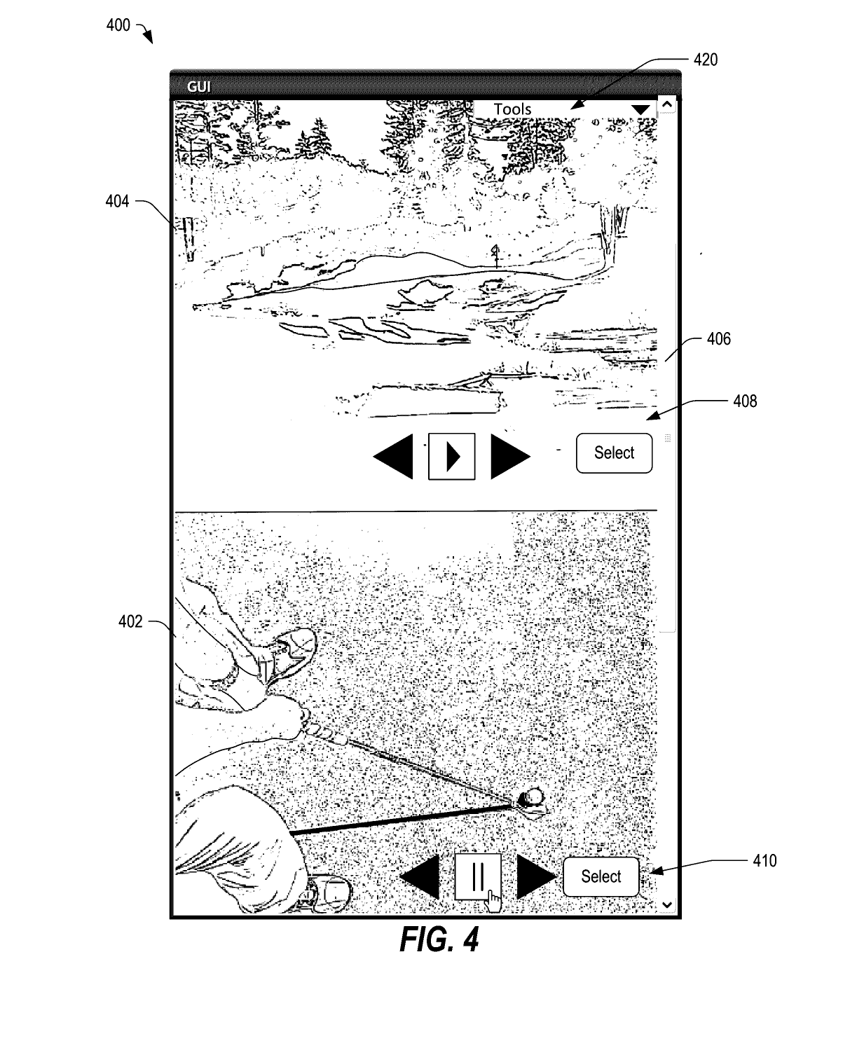

FIG. 4 depicts an interface 400 including optical data including a first portion 402 corresponding to a first focus area of the user and a second portion 404 corresponding to a second focus area of the user. By tracking the eye movements and focus of the user, the system may extract a first portion 402 based on the user's eye movements relative to the orientation of the user's head. For example, the first portion 402 may correspond to the user looking at the ball. Further, the system may extract a second portion 404, which may correspond to image data of a target area. In some examples, the system may determine the target area from the user's eye movements when the user turns his or her head.

The interface 400 further includes a scroller element 406 that can be selected by the user to adjust the view up or down. Further, the interface 400 may include selectable control elements 410 associated with the first portion 402 of the video. A user may interact with the selectable control elements 410 to play the video, allowing the video to advance until the user selects a “Pause” option, which may be represented by a square including two vertical lines, for example. The user may then interact with the triangular shaped options on either side of the “Pause” option to advance or rewind the video, frame by frame, until a desired frame is identified, which may be saved to memory by clicking on the “Select” button. Other selectable control elements 410 may also be included.

Further, the interface may include selectable control elements 408 associated with the second portion 404. A user may interact with the selectable control elements 408 to play the video, allowing the video to advance until the user selects a “Pause” option, which has previously been selected in this example. The user may select the “Play” option, which may be represented by a square with a triangle pointed toward a right side of the frame (for example), in order to advance the video. Further, the user may then interact with the triangular shaped options on either side of the “Play” option to advance or rewind the video, frame by frame, until a desired frame is identified, which may be saved to memory by clicking on the “Select” button. Other selectable control elements 408 may also be included.

In a particular example, the selected images or frames from the video may be stored to a memory and correlated to one another for use in a training context. Further, in some embodiments, the interface 400 may include a pull-down menu 420 from which the user may select one or more menus, tools, or other features of the interface. In an example, the user may select the tools menu 420 to access a drawing tool or a text tool for adding content to one or both of the images. Other features or tools may also be accessed via the pull-down menu 420. In alternative embodiments, tabs, menus, icons, tool bars, control panels, or other features may be provided within the interface 400 and may be selected by a user to access a selected feature or tool, which may be used to modify or add to the selected image, which additions may be stored with the selected frame in memory. In other examples, the video frame may be stored as an image in a standard image format, which may then be edited using other software, such as a publishing application or another application. Other embodiments are also possible.

While the above examples depicted a set up for a golf shot using an iron, it should be understood that the same tools may be used for putting, driving, recovery from a poor shot and other aspects of the game of golf. The resulting image data may be utilized for training purposes to teach golfers how to approach a particular situation.

Also, though the discussion above focused on golfers, the device and methods described may be used to capture situational data in a variety of circumstances, including sports (e.g., baseball, softball, basketball, tennis, and so on), driver training, classroom training, law enforcement training, military training, and so on. The resulting dual-image can show both the user's perspective view and the target area. By capturing the video of what a trained professional is looking for and what he/she sees, others can gain from the experience to learn quickly by viewing what an appropriate response can be from a first person perspective.

Although the present invention has been described with reference to preferred embodiments, workers skilled in the art will recognize that changes may be made in form and detail without departing from the scope of the invention.

What is claimed is:

1. A system comprising:
a wearable device including:
at least one optical sensor configured to capture optical data corresponding to a view area;
one or more eye tracking sensors configured to detect eye movement; and
a processor configured to determine a portion of the optical data based on the detected eye movement.

2. The system of claim 1, wherein the at least one optical sensor includes:
a first optical sensor configured to capture optical data corresponding to a forward view; and
at least one second optical sensor configured to capture optical data corresponding to a side view that is approximately orthogonal to the forward view.

3. The system of claim 2, wherein the portion of the image data is determined from at least one of the optical data corresponding to the forward view and the optical data corresponding to the side view based on the eye movement.

4. The system of claim 1, further including one or more sensors configured to determine movement and orientation of the wearable device.

5. The system of claim 1, wherein the wearable device further includes a transceiver configured to communicate at least one of the image data, the detected eye movement, and the portion of the image data to a computing device.

6. The system of claim 5, further comprising:
a computing device including:
a transceiver configured to receive at least one of the image data and the portion of the image data from the wearable device through a communication link;
a processor coupled to the transceiver; and
a memory accessible to the processor.

7. The system of claim 6, wherein the memory includes instructions that, when executed, cause the processor to:
receive the image data and the portion of the image data; and
provide a graphical interface including the image data, the portion of the image data, and one or more user-selectable options to select a first frame corresponding to the image data and a second frame corresponding to the portion.

8. A system comprising:
a wearable device including:
a transceiver;
at least one optical sensor configured to capture optical data corresponding to a view area;
one or more eye tracking sensors configured to detect eye movement;
a processor coupled to the at least one optical sensor, the one or more eye tracking sensors, and the transceiver, the processor configured to:
determine focal data correlating the eye movement relative to the optical data; and
communicate the optical data and the focal data to a computing device via the transceiver.

9. The system of claim 8, wherein the wearable device further includes one or more sensors configured to determine motion and orientation data corresponding to the wearable device.

10. The system of claim 9, wherein the processor is configured to determine the focal data based on the eye movement and the motion and orientation data.

11. The system of claim 8, wherein the at least one optical sensor comprises:
a first optical sensor configured to capture optical data corresponding to a forward view; and
at least one second optical sensor configured to capture optical data corresponding to a side view that is approximately orthogonal to the forward view.

12. The system of claim 11, wherein the portion of the image data is determined from at least one of the optical data corresponding to the forward view and the optical data corresponding to the side view based on the eye movement.

13. The system of claim 12, further comprising:
the computing device including:
a transceiver;
a processor coupled to the transceiver; and
a memory coupled to the processor, the memory including instructions that, when executed, cause the processor to:
receive the optical data and the focal data from the wearable device; and
generate a graphical interface including a first image from the first optical sensor and a second image from the at least one second optical sensor.

14. The system of claim 13, wherein the first image includes a portion of the optical data corresponding to the forward view that correlates to the focal data from the wearable device.

15. A method comprising:
capturing optical data corresponding to a forward view using at least one optical sensor of a wearable device;
determining, using eye tracking sensors of the wearable device, focal data corresponding to eye movements of a user; and
transmitting, using a transceiver of the wearable device, at least one of the optical data and the focal data to a computing device.

16. The method of claim 15, further comprising:
before transmitting, processing, using a processor of the wearable device, the optical data based on the focal data to determine a portion of the optical data corresponding to a perspective of the user; and
transmitting at least one of the focal data and the portion of the optical data to the computing device.

17. The method of claim 15, further comprising:
receiving, at a transceiver of the computing device, the optical data and the focal data; and
processing, using a processor of the computing device, the optical data using the focal data to determine a portion of the optical data corresponding to a perspective of the user.

18. The method of claim 17, further comprising generating a graphical interface using the processor, the graphical interface including at least a portion of the optical data corresponding to a perspective of the user and including one or more user-selectable elements.

19. The method of claim 18, further comprising receiving second optical data corresponding to a side view that is substantially orthogonal to the forward view.

20. The method of claim 19, further comprising generating a graphical interface using the processor, the graphical interface including:
at least a portion of the optical data corresponding to a perspective of the user and including one or more user-selectable elements; and
the second optical data corresponding to the side view.
